(19) United States
(12) Patent Application Publication
(10) Pub. No.: US 2014/0158619 A1
(43) Pub. Date: Jun. 12, 2014

(54) FILTERING DEVICES COMPRISING CLAY MINERALS

(71) Applicant: Gabriele Christoffel, Hilden (DE)

(72) Inventor: Gabriele Christoffel, Hilden (DE)

(73) Assignee: QIAGEN GMBH, Hilden (DE)

(21) Appl. No.: 14/233,524

(22) PCT Filed: Jul. 20, 2012
(86) PCT No.: PCT/EP2012/003074

§ 371 Date: Jan. 23, 2014

(30) Foreign Application Priority Data
Jul. 20, 2011 (EP) 11174671.5

(51) Int. Cl. B01D 39/20; B01D 69/14; B01D 15/08

(52) U.S. Cl. CPC B01D 39/2072; B01D 15/08; B01D 69/147
USPC 210/638; 210/263; 210/483; 210/287; 210/691; 210/266; 210/291

(57) ABSTRACT

The present invention relates to a filtering device comprising clay minerals for the filtration of aqueous solutions used in biochemical and molecular biological applications. In particular, the present invention relates to the removal of undesired proteins from aqueous solutions by filtration through a filter comprising clay minerals.

### TECHNICAL FIELD OF THE INVENTION

The present invention relates to a filtering device and methods for the filtration of solutions for applications in molecular biology and biochemistry. In particular, the present invention relates to the removal of undesired proteins from solutions, more in particular the removal of nucleases and proteases from solutions.

### BACKGROUND OF THE INVENTION

In biochemical and molecular biological techniques, the quality of biomolecules, e.g. proteins and nucleic acids, greatly affects the outcome of experiments such as accuracy and significance of the results. Degradation of nucleic acids and proteins by nucleases and proteases, respectively, is a major cause of loss of signal in assays or unsatisfactory yield in reactions. For many applications degrading enzymes, such as proteases and nucleases, particularly ribonucleases (RNases) and desoxyribonucleases (DNases), need to be inactivated or removed from any buffer or labware, e.g. glassware, used.

Aqueous solutions such as buffers often comprise contaminations of RNases and/or DNases which need to be removed for further use in molecular biological or biochemical applications. Particularly when dealing with RNA, one has to make sure that no RNase contaminations are present in reaction buffers.

Compared to DNA, RNA is much more damageable and easier to degrade. It is readily decomposed in conditions of extreme pH or in presence of metal ions and high temperatures. But the principal reason for RNA degradation represents the RNases. Therefore an adequate guard against nucleases during handling of RNA is of great importance. RNases are introduced into the system by cells and tissue samples as well as skin secretions and airborne microorganisms. Reasonable precautions must be followed to obtain an RNase-free environment during working with RNA as outlined in Blumberg 1987 (Methods Enzymol., 152:20-24). Several approaches to inactivate RNases exist but are mostly insufficient.

Heating is one possibility since some RNases show low activity at high temperature. Unfortunately, reduction of the temperature normally leads to a fully restored activity. Some RNases even withstand autoclaving, extreme pH values and urea, EDTA or SDS. Thus, it appears that inactivation of RNases is a complex enterprise.

To remove RNases, glassware may be baked at 180° C. for 8 hours or more. Plasticware may be rinsed with chloroform. Another approach is to incubate the glass- or plasticware for 2 hours at 37° C. in DEPC solution (0.1%) and rinse afterwards several times with DEPC treated water and autoclave them for 15 min (Blumberg 1987).

Working with DEPC is not recommendable since it is expensive and probably carcinogenic. Furthermore baking of the lab ware or treating it with DEPC is time consuming. Lab ware, which cannot be autoclaved, is cleaned by incubating it in a 3% solution of H₂O₂ for 10 min and rinsing with DEPC treated water afterwards.

Furthermore, RNase-free buffer solutions can be obtained by treatment with DEPC and subsequently autoclaving the buffer solution. Autoclaving the buffer solution after DEPC treatment is necessary to destroy the DEPC in the solution. However, this method cannot be employed with buffers containing amino groups. Furthermore, many buffers cannot be autoclaved. Autoclaving alone is not sufficient to destroy RNases in buffer solutions.

Therefore, no adequate method is available to remove or destroy RNases in many common buffer solutions.

Cleaning solutions for RNase-sensitive working areas are commercially available. Examples are RNaseZap (Ambion), RNase Away (Molecular BioProducts), Exitus Plus (AppliChem) and License to kill (BioDelta). Such commercially available solution typically use the denaturing effects of extreme pH. If pH is restored, the proteins might refold, so the inhibitory effect is not permanent. In a different approach a combination of denaturing and inhibiting agents are used, e.g. EDTA, SDS and a protein RNase Inhibitor. The inhibitory effect will not lead to an irreversible destruction of the RNases. Using an RNase Inhibitor is effective but pricy.

WO 2005/083081 discloses methods and compositions for inhibiting and/or inactivating nucleases by using nuclease inhibitors. These nuclease inhibitors comprise anti-nuclease antibodies and non-antibody nuclease inhibitors.

In other approaches, the mineral clay bentonite is used to remove ribozymes from lysates (Kaiser et al. 1971, Biochim Biophys Acta. 232(2):388-402) or to inhibit RNase activity during RNA isolation (Blackburn et al. 1967 Biochem. J. 102, 168).

### SUMMARY OF THE INVENTION

The present invention relates to a filtering device comprising an upper container and a filter comprising a clay mineral. Preferably, the clay mineral is a Montmorillonite clay. More preferably, the Montmorillonite clay is selected from the group comprising bentonite, organoclay and Macaloid or a combination, derivative or analogue thereof.

Preferably, said clay mineral is immobilized on a membrane or confined between membranes or within a filter housing.

The present invention also relates to the use of the filtering device according to the present invention or the methods according to the present invention for the removal of undesired proteins, e.g. as proteases and nucleases, particularly RNases and DNases from an aqueous solution.

Also within the scope of the present invention is a kit comprising the filtering device according to the present invention.

### DESCRIPTION OF THE DRAWINGS

FIG. 1 schematically illustrates filtration devices according to the present invention for the use in vacuum filtration. 1: Aqueous solution before filtration; 2: Clay filter for removal of RNases or other proteins; 3: Sterile filter for removal of e.g. micro organism; 4: Access for vacuum pump; 5: Retainer for filtrate.

FIG. 2 schematically illustrates filtration devices according to the present invention for the use in centrifugal filtration. 1: Aqueous solution before filtration; 2: Clay filter for removal of RNases or other proteins; 3: Sterile filter for removal of e.g. micro organism; 5: Retainer for filtrate.

FIG. 3 illustrates the effect of various pH conditions on the result of the filtration. Upper row (A): Bentonite solution applied to column, lower row (B): no bentonite applied. From left to right: pH 3, pH 5, pH 7, pH 10, for each pH condition (from left to right): Control (no RNase added), RNase concentration of 1 μg/ml, 10 μg/ml, 100 μg/ml and 1 μg/ml, respectively.

FIG. 4 illustrates the effect of dry bentonite (A) and pre-swollen bentonite (B) applied to a column.

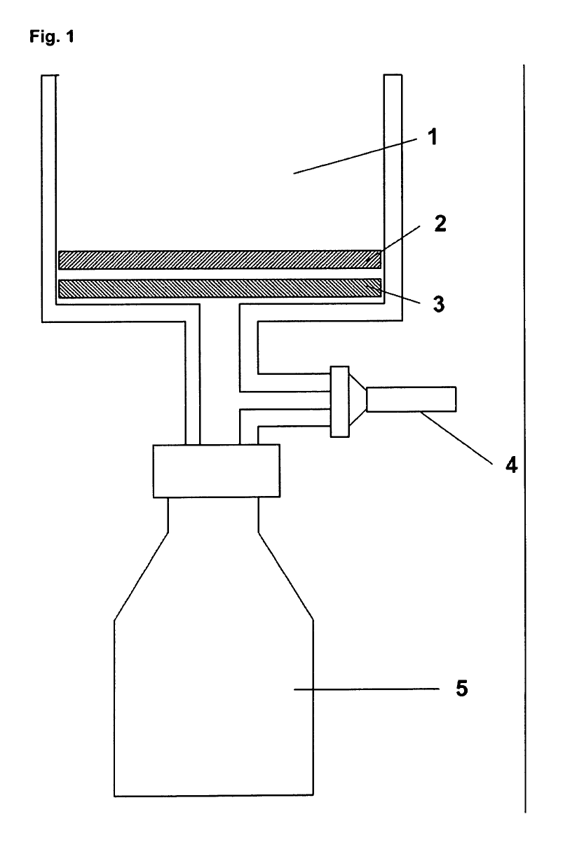

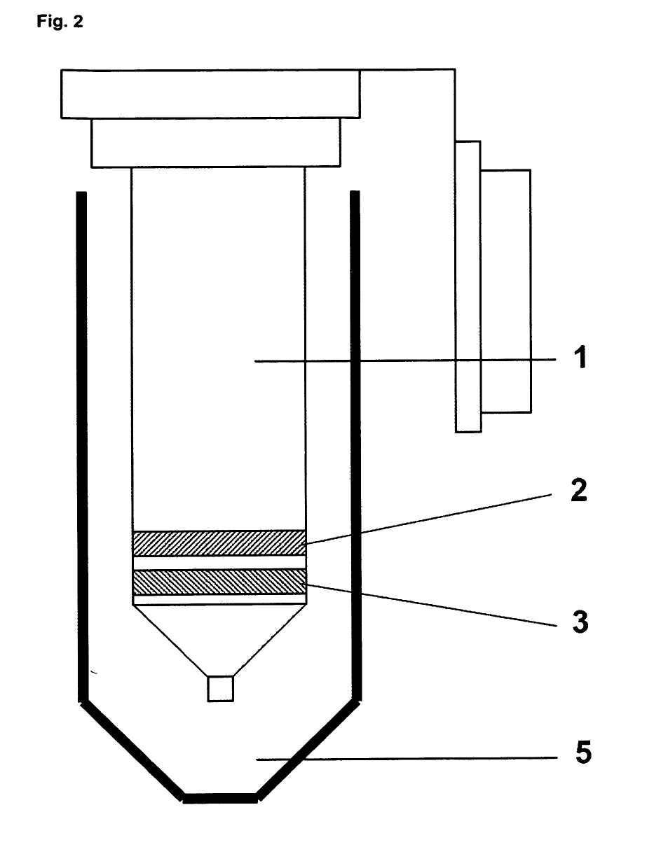

### DETAILED DESCRIPTION OF THE INVENTION

The present invention relates to a filtering device comprising an upper container and a filter comprising a clay mineral. Preferably, the clay mineral is a Montmorillonite clay. More preferably, the Montmorillonite clay is selected from the group comprising bentonite, organoclay and Macaloid or a combination, derivative or analogue thereof. Most preferably, the clay mineral is bentonite.

Clay is a naturally occurring material composed primarily of fine-grained minerals. Clay deposits are mostly composed of clay minerals (phyllosilicate minerals).

Montmorillonites are silicate minerals, particularly sheet minerals of the Phyllosilicate type. They preferably have formulae of (Na,K,Ca)_{0.33}(Al,Mg)₂(Si₄O₁₀)(OH)₂·nH₂O and the like. Bentonite is an aluminium Montmorillonite, whereas Macaloid is a magnesium Montmorillonite. Organoclay is an organically modified phyllosilicate, derived from a naturally occurring clay mineral. Organoclays are manufactured by modifying for example bentonite. For example, the original interlayer cations may be exchanged for organocations such as quaternary amines. Thereby, an organophilic surface is generated, comprising covalently linked organic moieties. Preferably, the amines have chain lengths of 12-18 carbon atoms.

Preferably, said clay mineral is immobilized on a membrane or confined between membranes or within a filter housing. Any type of membrane may be used as long as pore size is sufficient to hold back the clay mineral. This includes inorganic membranes, such as silica or glass fiber, or organic membranes, such as polyethersulfon, nylon, teflon, cellulose and cellulose derivatives (e.g. cellulose acetate, nitrocellulose). Other materials are obvious to those skilled in the art.

Other suitable membrane materials include for example mixed cellulose ethers and esters, polycarbonate (PC), polysulfone (PS), polyacrylonitrile (PAN), polyamide (PA), polyimide (PI), polyamide-imide (PAI), polyesters, polyethylene imine (PEI), polyethylene (PE), polypropylene (PP), polytetrafluoroethylene (PTFE), polyvinylidene fluoride (PVDF), polyvinylchloride (PVC), polyvinylpyrrolidone (PVP), polyvinylalcohol (PVOH), polydimethylsiloxane (PDMS), mixtures and/or blends thereof, or copolymers thereof, without being limited to these.

The membrane may be of homogeneous or heterogeneous structure, including multi-layer composite membranes. If the filtering device of the present invention comprises more than one membrane per device, the membranes may be the same or different. Multiple filtering devices may also be combined to a plate like in a multi-well plate, and used in parallel or subsequently.

In terms of the present invention, the membrane preferably may represent a porous membrane. Preferably the pore size is in a range of from about 0.005 μm to about 100 μm, more preferably of from about 0.01 to about 10 μm, including about 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8 and 9 μm and the ranges between any two of these values, and most preferably of from about 0.1 to about 1 μm.

The thickness of the membrane is not critical as long as it is chosen to provide sufficient mechanical stability for the intended use (e.g. vacuum filtration or filtration by spinning the filtering device in a centrifuge). The thickness range may depend for instance on the membrane materials(s) employed and can be easily determined by a person skilled in the art. It is preferred to use a membrane having a thickness ranging from several nanometers up to centimeters, e.g. of from about 20 nm to about 5 cm, preferably of from about 100 nm to about 1 cm, more preferably of from about 1 μm to about 1 mm, including about 2, 3, 4, 5, 6, 7, 8, 9, 10, 20, 30, 40, 50, 60, 70, 80, 90, 100, 200, 300, 400, 500, 600, 700, 800, and 900 μm and the ranges between any two of these values.

The clay mineral may be added by e.g. pipetting to a filter membrane. It may be added as a solution or as a dry or pre-swollen clay, but preferably is added to the device before said device is contacted with the suspensions, liquids and/or solution(s) to be filtered.

The filtering device may additionally comprise one or more additional filter and/or separation media. A suitable additional filter medium may be a sterile filter membrane, i. e. a filter membrane to be used for the removal of microorganisms from a solution to be filtered.

The sterile filter may in particular have pore sizes of from about 0.2 to 0.45 μm. The sterile membrane may be used to remove cells such as microbiological organisms by filtration from the liquid to be filtered. A suitable separation medium may be a gel (permeation) chromatography medium that can be used e.g. to additionally remove salts or other contaminants. Suitable gel (permeation) chromatography media are particles with hydrophilic and porous properties that are highly cross-linked. Examples for suitable gel (permeation) chromatography media are modified polysaccharide like Sephadex or Sepharose, cross-linked polyacrylamide, agarose gel, glass, dextran or silica gel.

In case of a combination of one or more single filters and/or one or more separation medium/media they may be in direct contact with each other or separated by a suitable compartmentation medium, like a frit or a membrane, which should be permeable for all substances that are not withheld by the filter or separation media positioned above said compartmentation medium.

The filtering device may preferably additionally comprise a retainer for the filtrate.

The filtering devices according to the present invention may have different dimensions depending on the volume to be filtered. In particular for larger volumes to be filtered the volume of the upper container of the filtering device of the present invention (and accordingly the retainer too, if present) preferably may be in the range of from about 50 μl to 100 l, more preferably in the range of from about 0.1 ml to 50 l, even more preferably of from about 0.5 ml to 1 l.

Preferably, centrifugal filtering devices have dimensions suitable for the use in combination with standard reaction tubes, e. g. made of glass or plastic, for example microcentrifuge tubes with volumes of 0.5 ml, 1.5 ml and 2 ml or standard conical or round-bottom tubes, e.g. polypropylene or polystyrene tubes with volumes of 15 ml or 50 ml. Also vacuum filtering devices having dimensions suitable for the use in combination with standard flasks, e. g. having a volume of 500 ml or 1 l, may be preferred. Preferably, larger volumes, e.g. volumes above 50 ml, particularly volumes of more than 100 ml up to several hundreds of ml or several liters, are filtered by vacuum filtration and the filtering devices for larger volumes are vacuum filtering devices. Smaller volumes, e.g. in the range of from about 10 μl to 50 ml are preferably filtered by centrifugation using centrifugal filtering devices. Thus, the filtering device may in one embodiment be a centrifugal filtering device or may in another embodiment be a vacuum filtering device or may in a further embodiment work with gravity flow. A vacuum filtering device may preferably comprise an access for a vacuum pump.

The present invention also relates to a method for the removal of proteins, particularly undesired proteins, from a solution, in particular from an aqueous solution comprising filtering the (aqueous) solution through a filter system comprising a clay mineral, preferably the filter device of the present invention as described above in detail. Using the filtering device of the present invention already comprising the Montmorillonite clay before being contacted with the solution, preferably the aqueous solution to be filtered, no additional steps of adding such a clay to the solution prior to filtering are necessary. As the Montmorillonite clay may be fixed in the filtering device, e. g. by immobilizing it on a membrane or configuring it between membranes, even Montmorillonite clay powder may be used, which otherwise would clog a filter of small pore size, e. g. of about 0.2 to 0.45 μm, and/or pass a filter of rather large pore size, e. g. of about >1 μm to 100 μm.

The undesired proteins may be selected from the group comprising proteases and nucleases. The nucleases may for example be ribonucleases (RNases) or desoxyribonucleases (DNases). E.g. the removal of RNases is desired and important when working with RNA.

Preferably, the clay mineral used in the method of the present invention may be a Montmorillonite clay, more preferably selected from the group comprising bentonite, organoclay and Macaloid or may be a combination, derivative or analogue thereof. Most preferably the clay mineral is bentonite.

Preferably, the solution, in particular the aqueous solution, from which the undesired proteins are to be removed is a liquid, preferably an aqueous, composition or a buffer that may be used for the lysis of nucleic acid containing cells, and/or for the purification, homogenization, characterization, modification, detection and/or preparation of biomolecules, like e.g. nucleic acids. Examples for solutions to be filtered are lysis solutions, wash solutions, including pure water, elution solutions, binding solutions, sample stabilizing solutions, extraction solutions, precipitation solutions, gel loading solutions or solutions used for amplification reactions, methylation reactions, and/or marking reactions and/or any other liquid supposed to be used in a molecular biology application. It is preferred that the solution to be filtered is not a beverage, preferably not an alcoholic beverage, most preferred no wine.

The clay mineral preferably may be immobilized on a filter membrane or confined between membranes or within a filter housing. In another preferred embodiment of the method, the clay mineral is added to a filter membrane by e.g. pipetting, before the filtration.

The method for removal of undesired proteins from an aqueous solution may additionally comprise filtering the aqueous solution through a sterile filter. This is in particular to remove microorganism, e.g. bacteria or fungi, from said solution.

It may be preferred to allow the aqueous solution to be filtered to incubate on said clay before filtration, e.g. before applying centrifugal forces or vacuum. Preferably, the incubation time is in the range of from 1 to 30 minutes, e.g. 1 min, 2 min, 5 min, 10 min or 15 min.

In some embodiments of the invention, a dry clay mineral is used.

In other embodiments of the method of the present invention, the clay mineral is pre-swollen, e.g. pre-swollen in water or a buffer. In a particular embodiment the pre-swollen clay mineral is let dry on a membrane before filtration.

The methods of the present invention and the use of the filtering devices according to the present invention are not limited to the filtration of a particular buffer or solution. Commonly used buffers and their preferred pH ranges are known to a skilled person. Such buffers may, inter alia, be selected from the group comprising MES, Bis-Tris, ADA, aces, PIPES, MOPSO, Bis-Tris Propane, BES, MOPS, TES, HEPES, DIPSO, MOBS, TAPSO, Trizma, HEPPSO, POPSO, TEA, EPPS, Tricine, Gly-Gly, Bicine, HEPBS, TAPS, AMPD, TABS, AMPSO, CHES, CAPSO, AMP, CAPS, CABS, phthalate, acetate, Tris, phosphate and citrate buffers and mixtures thereof. In one embodiment the buffer or aqueous solution does not contain more than 10 vol.-%, preferably not more than 5 vol.-%, more preferably not more than 1 vol.-%, even more, preferably not more than 0,1 vol.-% of methanol, ethanol and/or isopropanol and most preferably no methanol, ethanol and/or isopropanol.

Preferably, the buffer used for pre-swelling has a pH in the range of from about pH 2 to pH 11, more preferably in the range of from about pH 3 to pH 10. It may be even more preferably in the range of from about pH 3 to <pH 7 or from about >pH 7 to pH 11, still even more preferably in the range of from about pH 4 to pH 6, e. g. pH 4.5 to pH 5.5, or from about pH 8 to pH 10.5. It may be particularly preferred that the buffer has a pH of about 10.

Preferably, the buffer to be filtered has a pH in the range of from about pH 2 to pH 11, more preferably in the range of from about pH 3 to pH 10. It may be even more preferably in the range of from about pH 3 to <pH 7 or from about >pH 7 to pH 11, still even more preferably in the range of from about pH 4 to pH 6, e. g. pH 4.5 to pH 5.5, or pH 8 to pH 10.5. It may be particularly preferred that the buffer has a pH of about 10.

The buffer may in an illustrative embodiment be a 2-amino-2-hydroxymethyl-propane-1,3-diol based buffer (trishydroxymethylaminomethane, Tris), preferably a Tris buffer with pH of around 10.

The solutions and/or buffers may comprise one or more additional components, independently selected e.g. from the group of salts, including inorganic as well as organic salts, complexing agents, surfactants, detergents, chaotropic agents, organic solvents, like alcohols or acids, colorants, primers or nucleotides.

Preferably, the clay mineral does not pass the filter membrane during filtration, i.e. it is preferred that no clay mineral is in the filtrate. However, in some embodiments, residual clay mineral may be removed from the filtrate by additional centrifugation or filtration steps.

In some embodiments of the invention, it may be additionally necessary to pre-treat the glass- or plastic-ware used to remove unwanted proteins, e.g. by autoclaving, pre-baking and/or or rinsing with DEPC. Particularly the retainer for retaining and/or storing the filtrate needs to be sterile and free of undesired protein.

The filtering in the method for the removal of undesired proteins is preferably performed using a vacuum filter device or a centrifugal filter device, e.g. a spin column or by gravity flow.

The present invention also relates to the use of the filtering device according to the present invention or the methods according to the present invention for the removal of undesired proteins, e.g. as proteases and nucleases, particularly RNases and DNases, preferably RNases, from a solution, preferably an aqueous solution, in particular a liquid composition or buffer as already described above in detail, particularly when intended for use in a nucleic acid treatment procedure like isolation or purification.

Also within the scope of the present invention is a kit comprising a filtering device as described above. The kit may in some embodiments be used the removal of undesired proteins, e.g. as proteases and nucleases, particularly RNases and DNases, from an aqueous solution. Further, the kit may comprise aqueous and/or non-aqueous solutions, in particular liquid compositions and/or buffers as described above, one or more identical or different plastic consumables, like e.g. tubes or columns, one or more enzymes for example DNases or RNases that preferably are removed by the filtering device after the enzymatic treatment and/or instructions for using the kit.

An advantage of the devices and methods of the present invention is the removal of undesired proteins, preferably nucleases, most preferably RNases, from aqueous solutions instead of solely inhibiting these proteins.

### EXAMPLES

### Example 1

### Determination of Optimum Conditions for RNase Removal and/or Inhibition by Bentonite Filtration on a Spin Column

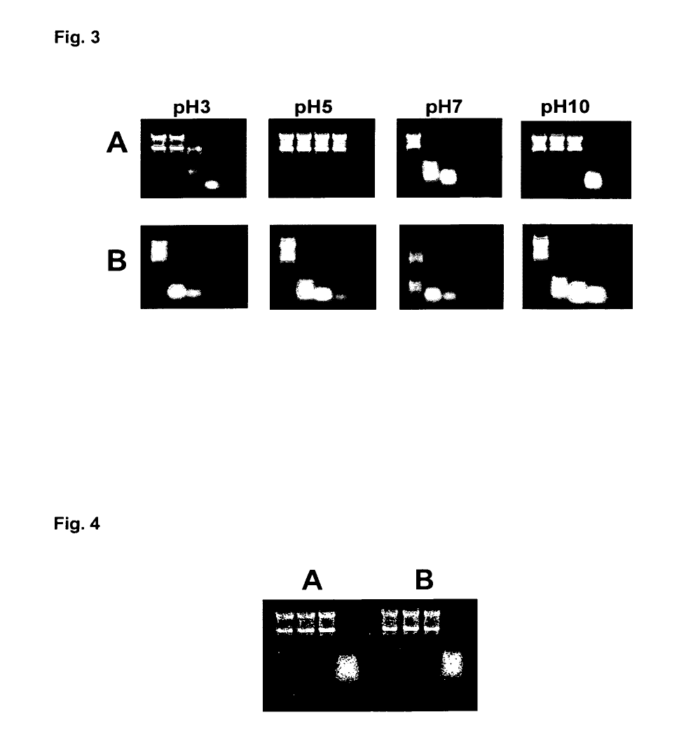

RNeasy spin columns (Qiagen) were loaded with 100 μl aqueous bentonite solution (in water and in the following buffers: potassium hydrogen phthalate pH 3; sodium acetate pH 5; MOPS pH 7; Tris pH 10; bentonite concentration: 100 mg/ml) each (control: solution with no bentonite). The fluid was removed by centrifugation (3 min, 14000 g). 100 μl of RNase solution (having an RNase concentration of 1 mg/ml, 100 μg/ml, 10 μg/ml and 1 μg/ml, respectively; control: no RNase; stock solution: 100 mg/ml RNase) was added by pipetting to the bentonite treated columns and incubated for 15 min. Then the columns were centrifuged for 3 min at 14000 g. Afterwards, 8 μl of RNA-containing solution (corresponding to about 4 μg RNA) buffered at different pH (potassium hydrogen phthalate pH 3; sodium acetate pH 5; MOPS pH 7; Tris pH 10) was added to 2 μl of each flow-through and allowed to incubate for 15 min at room temperature. After addition of an RNA marker, the solution was separated by a formaldehyde agarose gel. The result of the gel electrophoresis is shown in appended FIG. 3.

The images of the stained gels in FIG. 3 demonstrate that at all pH values a complete degradation of RNA was observed for the highest concentration of RNase (RNase concentration from left to right in FIG. 3: in the first lane: control (no RNase added), then 1 μg/ml, 10 μg/ml, 100 μg/ml, 1 mg/ml RNase applied). At the other RNase concentrations no degradation was observed at pH 5, a slight degradation at pH 10, a medium degradation at pH 3 and a strong degradation at pH 7. In the control experiments with no bentonite, degradation was always observed, except for the cases where no RNase was added (control). The optimum pH condition for filtration with bentonite is therefore at slightly acid pH, like at about 5 pH and at around pH 10.

Nevertheless, using the method of the present invention, a reduction of RNA degradation can be observed at any pH tested.

In addition, the effect of pre-swelling was determined. FIG. 4 illustrates that no difference could be observed when using dry bentonite (A in FIG. 4) instead of a bentonite solution (B in FIG. 4).

1.-15. (canceled)

16. A filtering device comprising:
an upper container, and
a filter comprising a Montmorillonite clay mineral selected from the group consisting of bentonite, organoclay, Macaloid, and combinations, derivatives, and analogue thereof

17. The filtering device of claim 16, wherein said clay mineral is immobilized on a membrane, confined between membranes, or within a filter housing,

18. The filtering device of claim 17, wherein the membrane(s) is/are selected from the group consisting of silica, glass fiber, and organic membranes.

19. The filtering device of claim 16, additionally comprising a sterile filter membrane.

20. The filtering device of claim 16, additionally comprising a retainer for the filtrate.

21. The filtering device of claim 16, wherein the filtering device is a centrifugal filtering device or a vacuum filtering device or works with gravity flow.

22. A method for removing proteins from an aqueous solution, comprising: filtering the aqueous solution through a filter system comprising a clay mineral.

23. The method of claim 22, wherein the proteins are selected from the group consisting of proteases and nucleases.

24. The method of claim 23, wherein the clay mineral is a Montmorillonite clay selected from the group consisting of bentonite, organoclay, Macaloid, and combinations, derivatives and analogues thereof.

25. The method of claim 22, wherein the aqueous solution is a buffer for cell lysis or the purification, characterization and/or preparation of nucleic acids.

26. The method of claim 22, wherein the clay mineral is immobilized on a filter membrane, confined between membranes, or within a filter housing.

27. The method of claim 22, additionally comprising filtering the aqueous solution through a sterile filter.

28. The method of claim 22, wherein the clay mineral is pre-swollen.

29. The method of claim 22, wherein the clay mineral is dry.

30. The of claim 22, wherein filtering is performed using a vacuum filter device or a centrifugal filter device or by gravity flow.

31. A kit comprising a filtering device of claim 16.
